(19) United States
(12) Patent Application Publication
(10) Pub. No.: US 2012/0272824 A1
(43) Pub. Date: Nov. 1, 2012

(54) METHOD FOR DRYING NATURAL GAS BY THE JOINT COOLING OF SOLVENT AND NATURAL GAS

(75) Inventor: Johannes Menzel, Waltrop (DE)

(73) Assignee: THYSSENKRUPP UHDE GMBH, Dortmund (DE)

(21) Appl. No.: 13/496,146

(22) PCT Filed: Sep. 13, 2010
(86) PCT No.: PCT/EP2010/005597

§ 371 Date: Apr. 6, 2012

(30) Foreign Application Priority Data
Sep. 14, 2009 (DE) 10 2009 041 104.6

(51) Int. Cl. B01D 53/26

(52) U.S. Cl. 95/185; 95/186

(57) ABSTRACT

A process for the drying of gases which are routed through two or more gas coolers connected in series. The coolers being supplied with a solvent stream absorbing water from the gas entering the respective cooler, with a mixed stream consisting of gas and solvent entering each of these gas coolers, then being routed through the respective cooler and, after joint cooling in the respective cooler, being separated by a gas/liquid separator in the outlet of the respective cooler into a gas stream of reduced water content and a solvent stream laden with water. The water content of the gas is successively reduced from the first cooler to the last cooler and the solvent stream separated and laden with water being either used as feed stream for the upstream cooler or directly returned to the solvent regeneration unit where the water-enriched solvent is again freed from water.

The invention relates to a process for the drying of industrial gases and in particular of natural gas. In a multitude of cases the drying of gases is performed in such a manner that a water-absorbing solvent is brought into contact with the water-containing gas at—usually—ambient temperature such that the solvent absorbs the water contained in the gas, The water is removed from the solvent by evaporation and the solvent thus regenerated.

U.S. Pat. No. 3,105,748 A describes a process for water removal from gases and in to particular from natural gas, the water contained in the gas being removed by an absorbing solvent which is circulated in a loop and conveyed for regeneration to a regeneration column or a contrivance of similar type in which the solvent is heated, such that the water contained in the solvent evaporates completely and, in thin-film evaporators, thin films of the regenerated solvent are brought into contact with dry gas, such that the solvent is further dried.

In state-of-the-art processes the contact between gas and solvent is normally established in an absorption column via the respective mass transfer internals, such as trays, random packings and structured packing& As in a conventional drying unit the absorption column is clearly the most expensive equipment item, it would be favourable to reduce the drying costs in this section, Therefore, it is the objective to make available a process and contrivance which performs water absorption in a more cost-efficient contrivance if possible.

The invention achieves the objective by performing the drying by the joint cooling of gas and solvent. The gas is dried by absorption of the water contained in the gas using a solvent suited for gas drying in a temperature range from 50° C. to −20° C., the joint cooling of the solvent and the gas to be purified being performed according to the invention in several coolers connected in series. The gas/solvent mixture leaving the respective coolers is separated in a downstream gas/liquid separator. By means of the coolers charged with solvent and connected in series it is possible that a column normally used for drying can be completely dispensed with, resulting in a maximum saving in the absorption of water from the feed gas, As in a conventional drying unit the absorption column is clearly the most expensive equipment item, a significant cost saving is also achieved for the entire drying unit.

Running the drying process in at least two heat exchangers or coolers connected in series makes it possible to dry the respective feed gas to a very low outlet water content.

A low temperature level of both media causes an improved absorption of water into the absorbing solvent whereas, on the other hand, the dew point of the gas is reduced by cooling to such a degree that a very intensive absorption of water by the solvent is possible. The invention also relates to a contrivance with the aid of which the to process can he run. The invention will he of particular advantage if the gas is or musk be cooled to lower temperatures anyway independent of the requirements for drying.

However, the invention can also be applied advantageously if the gas is cooled to ambient temperature only as in the case of the conventional gas drying. For this purpose, the cooling which normally takes place in one contrivance can be performed in two, three or several contrivances connected in series, the total area required for cooling being only slightly greater than in the case of a single contrivance.

Downstream of the respective coolers the solvent is conveyed from the gas/liquid separators to a regeneration unit where the water is removed by heating and evaporation. The regenerated solvent is re-circulated and fed to the gas/solvent mixture upstream of the coolers. The process can be modified in such a manner that a solvent pre-laden with water from at least one gas/liquid separator is fed to the gas upstream of a cooler which, in flow direction, is located upstream of that cooler from which the solvent laden with water had been withdrawn. The purified and dried gas can be withdrawn from the last gas/liquid separator in gas flow direction. The drying efficiency can be further increased by modifying the number of coolers or the solvent recirculation system.

In detail the invention achieves the objective by a process for water removal from natural and industrial gases, in which

a solvent freed from water is supplied for gas drying from a solvent and which is characterised in that

the feed gas is routed through two or more than two coolers connected in series, each of these coolers being supplied with a solvent stream which absorbs water from the gas entering the respective cooler, and

a mixed stream consisting of gas and solvent enters each of these coolers, is then routed through the respective cooler and, after joint cooling in the respective cooler, separated by means of the associated gas/liquid separator in the outlet of the respective cooler into a gas stream of reduced water content and a solvent stream laden with water, and

the water content of the gas is gradually reduced from the first cooler in flow direction to the last cooler in flow direction, each solvent stream separated and laden with water being either used as feed stream for an upstream cooler or directly returned to the solvent regeneration unit where the water-enriched solvent is freed almost completely from water again, and

the gas outlet temperature of a cooler located downstream in flow direction is lower than the gas outlet temperature of the cooler located upstream of it in flow direction.

By that process the drying effect can be intensified from cooler to cooler, as the temperature decreases in any subsequent cooling stage. A very intensive absorbing of water by the solvent is possible by that embodiment of the process, and, as a consequence, the absorbing of water can be performed in a more cost efficient apparatus.

The inventive process can, for example, be modified in such a manner that a regenerated solvent stream from the solvent regeneration unit is supplied to all coolers connected in series upstream of the entry to these coolers, and that the respective water-laden solvent stream separated in the gas/liquid separators is returned to the solvent regeneration unit for water removal.

The inventive process can, for example, be modified further in such a manner that a regenerated solvent stream from the solvent regeneration unit is fed to the gas stream of the last cooler in flow direction of the coolers connected in series upstream of the entry to this cooler, and that the respective solvent stream separated by the gas/liquid separator of the respective downstream cooler is supplied to all other coolers installed upstream in flow direction, and that the water-laden solvent obtained from the first gas/liquid separator in flow direction is returned to the solvent regeneration unit for water removal.

The inventive process can, for example, be modified further in such a manner that a regenerated solvent stream from the solvent regeneration unit is fed to the respective gas streams of the first and the last cooler in flow direction of the coolers connected in series upstream of the entry to these coolers, and that the respective solvent stream separated by the gas/liquid separator of the respective downstream cooler is supplied to all other interposed coolers, and that the water-laden solvent stream separated by the first and second gas/liquid separators in flow direction is returned to the solvent regeneration unit for water removal.

In an embodiment of the process the separation device required for the is respective gas/liquid separation is designed to be integrated in the respective cooler. The required separation device can be of any type. In a preferred embodiment the required separation device is a lamella separator.

In principle, the distribution and return of the individual solvent streams from the gas/liquid separators to the solvent regeneration unit can be designed in any form. In principle, the supply of fresh solvent from the solvent regeneration unit or the last gas/liquid separator can also be designed in any form. The solvent regeneration unit is, for example, a regeneration column.

In an advantageous embodiment the solvent stream from the last gas/liquid separator is divided, the individual part-streams being routed in at least two gas-containing solvent streams to the entry of each cooler. In a further embodiment the regenerated solvent stream from the solvent regeneration unit can also be divided and routed in at least one gas-containing solvent stream to the entry of each cooler.

The physical solvents ethylene glycol, diethylene glycol, triethylene glycol or tetraethylene glycol or a mixture of these substances can be used as solvent. Also used as physical solvent can be physical solvents N-methylmorpholine or N-acetylmorpholine or a mixture of these substances. In addition, the solvents methanol or alkylated polyethylene glycols or a mixture of these substances can be used as physical solvent.

The inventive process has the advantage that the absorption of water from a natural gas to be dried can be performed without a costly absorption column. The dew point of water in the gas to be treated can considerably be reduced by a suitable connection of the individual plank sections. The invention also claims a contrivance with the aid of which this process can be run.

The inventive embodiment of a process for the purification of a sour-gas-containing hydrocarbon stream is explained in more detail on the basis of three drawings, the inventive process not being restricted to these embodiments.

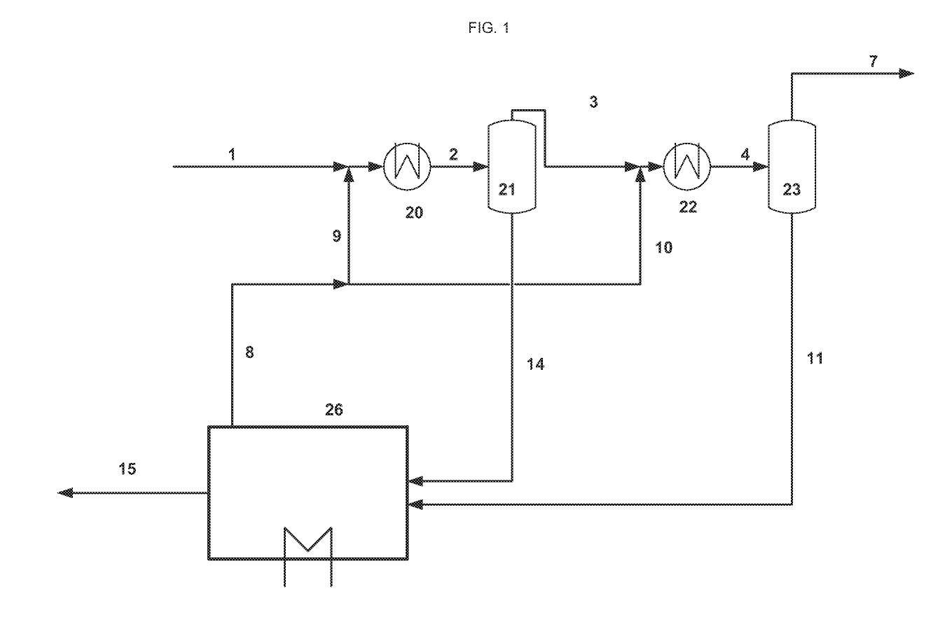

FIG. 1: A gas stream to be treated M) is mixed with a solvent almost completely free of water (9) and routed via a first cooler (20), giving a solvent-containing gas stream (2) which is then conveyed to a first gas/liquid separator (21) yielding a water-containing solvent stream (14) and a pre-dried gas (3). The pre-dried gas stream (3) is mixed with a second part-stream of the regenerated solvent (10) and then jointly conveyed to a second cooler (22), a solvent-containing gas stream (4) being obtained. The solvent absorbs most part of the residual water from the gas. The separation of the dried gas (7) from the water-containing solvent stream (11) takes place in the second gas/liquid separator (23). The water-containing solvent streams (11,14) from the liquid separators (22,23) are returned to the solvent regeneration unit (26). The water absorbed by the solvent is separated from the solvent in the solvent regeneration unit (26) and leaves the unit as waste steam or waste water stream (15). The solvent stream almost completely free of water (8) is then again available for gas drying.

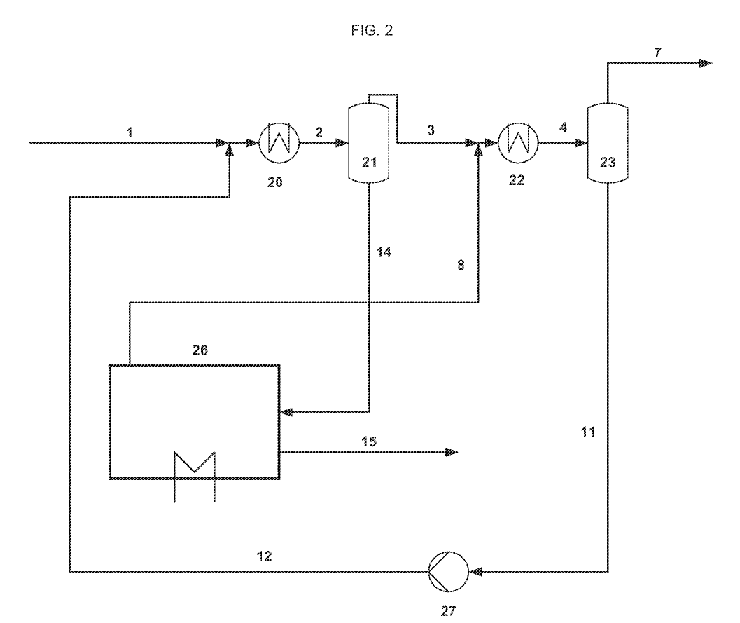

FIG. 2: A gas stream to be treated (1) is mixed with a water-containing solvent stream from pump (12), which is withdrawn from the gas/liquid separator (23), and routed via a first cooler (20), a solvent-containing gas stream (2) being obtained. This stream is fed to a first gas/liquid separator (21), a water-containing solvent stream (14) and a pre-dried gas (3) being obtained. The pre-dried gas stream (3) is mixed with a solvent stream almost completely free of water (8) and conveyed to a second cooler (22), a solvent-containing gas stream (4) being obtained. The solvent absorbs most part of the residual water from the gas. The separation of the dried gas (7) from the water-containing solvent stream (11) takes place in the second gas/liquid separator (23). By means of a pump (27) the water-containing solvent stream (11) from the second gas/liquid separator (23) is recycled to upstream of the first cooler (20). The water-containing solvent stream (14) from the first gas/liquid separator (21) is returned to the solvent regeneration unit (26). The water absorbed by the solvent is separated from the solvent in the solvent regeneration unit (26) and leaves the unit as exhaust steam or waste water stream (15), The solvent stream almost completely free of water (8) is then again available for gas drying.

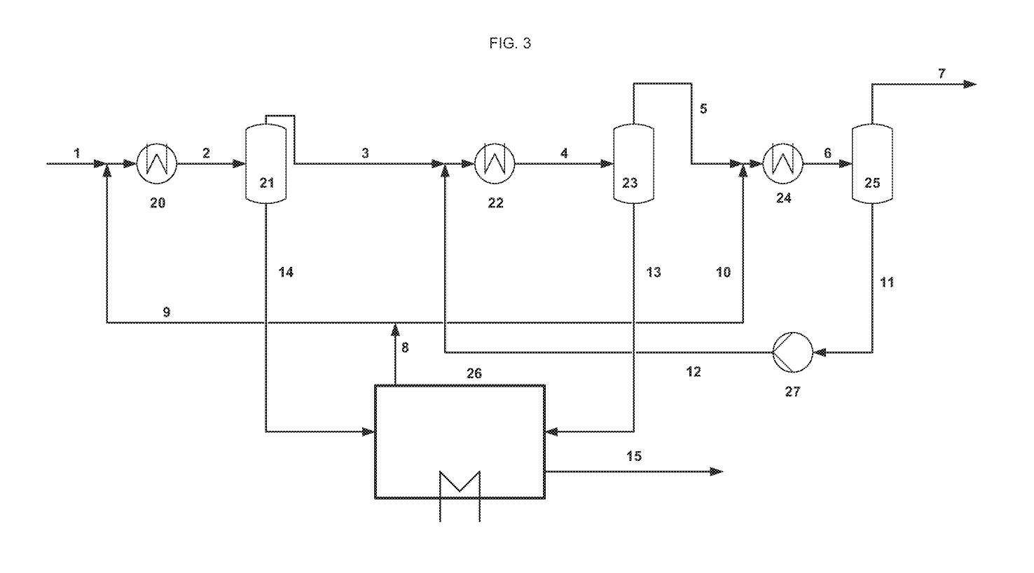

FIG. 3: A gas stream to be treated (1) is mixed with a solvent almost to completely free of water (9). The gas/liquid mixture passes through a first cooler (20), a solvent-containing gas stream (2) being obtained. The water-containing solvent stream (14) is separated from the pre-dried gas stream (3) in the first gas/liquid separator (21). The pre-dried gas stream (3) is mixed with a water-containing solvent stream (12). The gas/liquid mixture generated thereby is jointly cooled in a second cooler (22), a solvent-containing gas stream (4) being obtained. The separation of the pre-dried gas (5) from the water-containing solvent stream (13) takes place in the gas/liquid separator (23). A second regenerated solvent stream (10) is supplied to the pre-dried gas stream (5) leaving the second gas/liquid separator (23), The gas/liquid mixture then jointly passes through the third cooler (24) also yielding a solvent-containing gas stream (6). The solvent absorbs most part of the residual water from the gas. The separation of the dried gas (7) from the water-containing solvent stream (11) takes place in the gas/liquid separator (25). By means of a pump (27) the water-containing solvent stream (12) is recycled to upstream of the second cooler (22) for further drying of the pre-dried gas (3).

The water-containing solvent stream (14) from the first gas/liquid separator (21) and the water-containing solvent stream (13) from the second gas/liquid separator (23) are returned to the solvent regeneration unit (26). The water absorbed by the solvent is separated from the solvent in the solvent regeneration unit (26) and leaves the unit as exhaust steam or waste water stream (15), The solvent stream almost completely free of water (8) is then again available for gas drying.

A modification of the process configuration described in FIG. 3 is provided in that the water-containing solvent stream (13) leaving the second gas/liquid separator (23) is not returned to the solvent regeneration unit but is routed together with the first part-stream of regenerated solvent (9) to upstream of the first cooler (20).

### LIST OF REFERENCES USED

1 Gas stream to be treated
2 Solvent-containing gas stream
3 Pre-dried gas
4 Solvent-containing gas stream
5 Pre-dried gas
6 Solvent-containing gas stream
7 Dried gas
8 Solvent stream almost completely free of water
9 First part-stream of regenerated solvent with solvent almost completely free of water
10 Second part-stream of regenerated solvent
11 Water-containing solvent stream
12 Water-containing solvent stream from pump
13 Water-containing solvent stream
14 Water-containing solvent stream
15 Exhaust steam/waste water
20 First cooler
21 First gas/liquid separator
22 Second cooler
23 Second gas/liquid separator
24 Third cooler
25 Third gas/liquid separator
26 Solvent regeneration unit
27 Pump

1. Process for the drying of natural gas by joint cooling of solvent and natural gases, in which
a solvent freed from water is supplied for gas drying from a solvent regeneration unit,
characterised in that
the feed gas is routed through two or more than two coolers connected in series, each of these coolers being supplied with a solvent stream which absorbs water from the gas entering the respective cooler, and
a mixed stream consisting of gas and solvent enters each of these coolers, is then routed through the respective cooler and, after joint cooling in the respective cooler, separated by means of the associated gas/liquid separator in the outlet of the respective cooler into a gas stream of reduced water content and a solvent stream laden with water, and
the water content of the gas is gradually reduced from the first cooler in flow direction to the last cooler in flow direction, each solvent stream separated and laden with water being either used as feed stream for an upstream cooler or directly returned to the solvent regeneration unit where the water-enriched solvent is freed from water again, and
the gas outlet temperature of a cooler located downstream in flow direction is lower than the gas outlet temperature of the cooler located upstream of it in flow direction,

2. Process for the drying of natural gas by joint cooling of solvent and natural gases according to claim 1, characterised in that a regenerated solvent stream from the solvent regeneration unit is supplied to all coolers connected in series upstream of the entry to these coolers, and that the respective water-containing solvent stream separated in the gas/liquid separators is returned to the solvent regeneration unit for water removal,

3. Process for the drying of natural gas by joint cooling of solvent and natural gases according to claim 1, characterised in that a regenerated solvent stream from the solvent regeneration unit is supplied to the gas stream of the last cooler in flow direction of the coolers connected in series upstream of the entry to this cooler, and that the respective solvent stream separated by the gas/liquid separator of the respective downstream cooler is fed to all other coolers installed upstream in flow direction, and that the water-containing solvent obtained from the first gas/liquid separator in flow direction is returned to the solvent regeneration unit for water removal

4. Process for the drying of natural gas by joint cooling of solvent and natural gases according to claim 1, characterised in that a regenerated solvent stream from the solvent regeneration unit is supplied to the respective gas streams of the first and last cooler in flow direction of the coolers connected in series upstream of the entry to these coolers, and that the respective solvent stream separated by the gas/liquid separator of the respective downstream cooler is supplied to all other interposed coolers, and that the water-containing solvent stream separated by the first and second gas/liquid separator in flow direction is returned to the solvent regeneration unit for water removal.

5. Process for the drying of natural gas by joint cooling of solvent and natural gases according to one of claims 1 to 4, characterised in that the separation device required for the respective gas/liquid separation is designed to be integrated in the respective cooler.

6. Process for the drying of natural gas by joint cooling of solvent and natural gases according to one of claims 1 to 5, characterised in that the separation device required for the gas/liquid separation is a separation device of the type of a lamella separator.

7. Process for the drying of natural gas by joint cooling of solvent and natural gases according to one of claims 1 to 6, characterised in that ethylene glycol, diethylene glycol, triethylene glycol or tetraethylene glycol or a mixture of these substances is used as physical solvent.

8. Process for the drying of natural gas by joint cooling of solvent and natural gases according to one of claims 1 to 6, characterised in that N-methymorpholine or N-acetylmorpholine or a mixture of these substances is used as physical solvent,

9. Process for the drying of natural gas by joint cooling of solvent and natural gases according to one of claims 1 to 6, characterised in that methanol or alkylated polyethylene glycols or a mixture of these substances is used as physical solvent,
